(19) United States
(12) Patent Application Publication
(10) Pub. No.: US 2008/0290828 A1
(43) Pub. Date: Nov. 27, 2008

(54) SYSTEM AND METHOD FOR DETECTING A STALLED MOTOR

(76) Inventors: Frank Joseph Haas, Northville, MI (US); Stephen Andrew Sageman, Canton, MI (US)

Correspondence Address: VISTEON/BRINKS HOFER GILSON & LIONE, 524 South Main Street, Suite 200, Ann Arbor, MI, 48104, US

(21) Appl. No.: 11/753,185

(22) Filed: May 24, 2007

(51) Int. Cl. H02P 7/18; H02P 3/00

(52) U.S. Cl. 318/434

(57) ABSTRACT

A system for detecting when a motor is stalled. The system including a voltage driving circuit and a voltage sensing circuit. The voltage driving circuit providing a driving signal to the motor through a connection node. The voltage driver circuit being configured to disconnect from the connection node while the voltage sensing circuit determines if the motor is stalled. A voltage sensing circuit determines if the motor is stalled based on a generated voltage that occurs if the motor is not obstructed and continues to spin when the voltage driver circuit is disconnected.

### BACKGROUND

1. Field of the Invention

The present invention generally relates to a system and method for detecting a stalled motor.

2. Description of Related Art

In low cost DC motor control solutions, motors are often used to move doors or other objects to various positions that are limited by hard stops on both ends of a defined travel range or angle. Various means have been used to turn off the motor when the end stop position is reached. The motor is turned off to prevent damage to the motor, gear train, linkage, or object due to the high torque loads suddenly encountered at the stop points. Often external sensors may be used to determine when the stop limit has been reached. For example, Hall Effect sensors may be attached to the mechanism at limit points. Similarly, optical sensors or mechanically actuated limit switches may be attached to the mechanism to detect that the end of travel has been reached. In some scenarios, strain gauge sensors measure excessive torque in the mechanism when it acts against the end stops, thereby determining the end of the travel. Alternatively, a potentiometer type device may be mounted to the motor drive shaft providing direct feedback of the position. Accordingly, a controller may use voltage thresholds to determine when the end stops are expected. In other scenarios, a current sensing resistor may be put in series with the motor to detect when a large stall current exists. Alternatively, a controller may simply use a time based driving signal which turns off the current to the motor after a predetermined length of time corresponding to a longest case anticipated drive requirement. The scenarios provided above require additional hardware that increases the cost and often compromises the reliability of the system. The time based solution may require no additional hardware but provides very limited protection to the motor as repeatability of the system changes over time.

In view of the above, it is apparent that there exists a need for an improved system and method for detecting a stalled motor.

### SUMMARY

In satisfying the above need, as well as overcoming the enumerated drawbacks and other limitations of the related art, the present invention provides an improved system and method for detecting a stalled motor.

A system for detecting when a motor is stalled. The system including a voltage driver circuit and a voltage sensing circuit. The voltage driver circuit providing a driving signal to the motor through a connection node. The voltage driver circuit being configured to disconnect from the connection node while the voltage sensing circuit determines if the motor is stalled. A voltage sensing circuit determines if the motor is stalled based on a generated voltage that occurs if the motor is not obstructed and continues to spin when the voltage driver circuit is disconnected.

The voltage driving circuit includes outputs for providing the driving signal to the motor. The outputs may include a high impedance mode to disconnect the output from the connection node. The voltage driving circuit may disconnect from the connection node periodically and at a constant frequency. In addition, the voltage driving circuit may be provided in an H-bridge configuration. Further, the voltage driving circuit may reconnect to the connection node and provide the driving signal to the motor if the generated voltage is greater than a threshold voltage when the voltage driving circuit is disconnected. Alternatively, the voltage driver circuit may remain disconnected if the generator voltage is below the threshold voltage.

Further, the system may be configured to synchronize the measurement of the generated voltage with the disconnection of the voltage driver circuit. In addition, the system may remain disconnected based on multiple periodic measurements. As such, the voltage driver circuit may remain disconnected if the generated voltage is below a threshold voltage for a predetermined number of samples. To adjust for wear over time, the threshold voltage may be updated periodically.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for detecting a stalled motor in accordance with one embodiment of the present invention;

FIG. 2 is a diagram of a wave form when the voltage driver circuit is disconnected and the motor is not obstructed;

FIG. 3 is a diagram of a wave form when the voltage driver circuit is disconnected and the motor is not obstructed;

FIG. 4 is a diagram of a wave form when the voltage driver circuit is disconnected and the motor is obstructed;

FIG. 5 is a diagram of a wave form when the voltage driver circuit is disconnected and the motor is obstructed; and

FIG. 6 is a flow chart of method for detecting a stalled motor.

### DETAILED DESCRIPTION

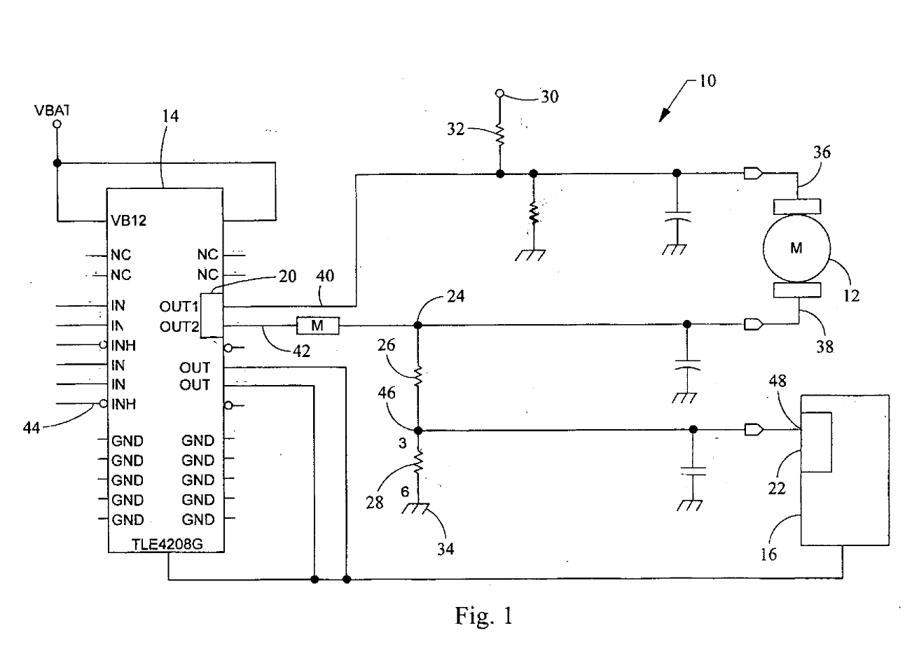

Referring now to FIG. 1, the system 10 may include a motor 12, a voltage driver circuit 14 and a voltage sensing circuit 16. The motor 12 may be a DC motor. The voltage driver circuit 14 is in electrical communication with the motor 12 to provide a driving signal thereby causing rotation of the motor 12. The motor driver circuit 14 may be an H bridge circuit and may be embodied in an integrated circuit, such as Part No. TLE 4208G manufactured by Infineon. The voltage driver circuit 14 includes a first output 40 connected to a first side 36 of the motor 12 and a second output 42 connected to a second side 38 of the motor 12. The first output 40 may be connected to a voltage source 30 through a pull up resistor 32. The voltage driver circuit 14 may include a switch.20 such as a solid state switch that disconnects the first and second output 40, 42 from the motor. The disconnected state may for example, be a tri-state mode where the first and second output 40, 42 have a high impedance and the integrated circuit operates in the low quiescent current mode. The switch 20 is activated when an inhibit signal is provided to an inhibit input 44 of the voltage driver circuit 14.

The second output 42 and the second side 38 of the motor 12 are connected to node 24. In addition, resistor 26 and resistor 28 are connected in electrical series connection between node 24 and an electrical reference 34, such as electrical ground. Resistor 26 and resistor 28 form a voltage divider allowing acquisition of a voltage at node 46, located between resistor 26 and resistor 28. A voltage sensing circuit 16 is connected to node 46 and is configured to receive a voltage signal into input 48 of the voltage sensing circuit 16. In addition, input 48 may be provided to an analog to digital converter 22 within the voltage sensing circuit 16. In one embodiment, the voltage sensing circuit 16 may be an integrated circuit or controller including the analog to digital converter 22. Further, the voltage sensing circuit 16 may be in communication with the voltage driving circuit 14 to synchronize acquisition of the voltage at input 48 while the first and second output 40, 42 are disconnected from the motor 12 by switch 20. While the voltage driver circuit 14 provides a driving signal to the motor 12, the first and second output 40, 42 may be periodically disconnected. If the motor 12 is not obstructed, for example, by the end of travel stop, the momentum of the motor 12 will allow it to continue spinning. Accordingly, the motor 12 will act as a voltage generator and a generated voltage will be measurable by the voltage sensing circuit 16, as the first and second output 40, 42 are disconnected.

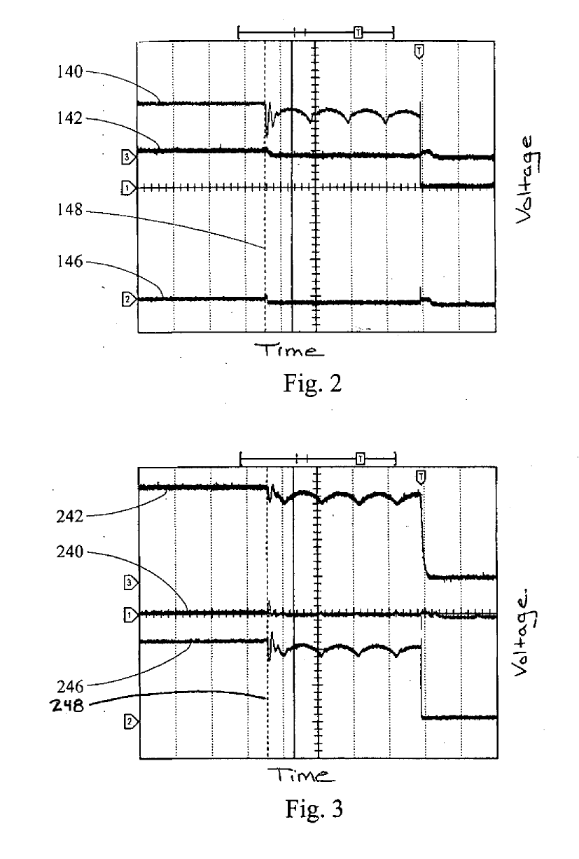

As shown in FIG. 2, the wave form 140 corresponds to the voltage at the first side 36 of the motor 12. Similarly, the wave form 142 corresponds to the voltage at the second side 38 of the motor 12. In addition, the wave form 146 corresponds to the voltage at node 46 received by voltage input 48. The motor 12 is driven in a first direction as the voltage on the first side 36 of the motor 12 is high (waveform 140). The first and second output 40, 42 are then disconnected as denoted by line 148. Since the motor 12 is not obstructed, waveform 140 remains high as the motor 12 continues to spin and generates voltage due to back EMF.

As shown in FIG. 3, the wave form 240 corresponds to the voltage at the first side 36 of the motor 12. Similarly, the wave form 242 corresponds to the voltage at the second side 38 of the motor 12. In addition, the wave form 246 corresponds to the voltage at node 46 received by voltage input 48. The motor 12 is driven in a second direction as the voltage on the second side 38 of the motor 12 is high (waveform 242). The first and second output 40, 42 are then disconnected, as denoted by line 248. Since the motor 12 is not obstructed, waveforms 242 and 246 remain high as the motor 12 continues to spin and generates voltage due to back EMF.

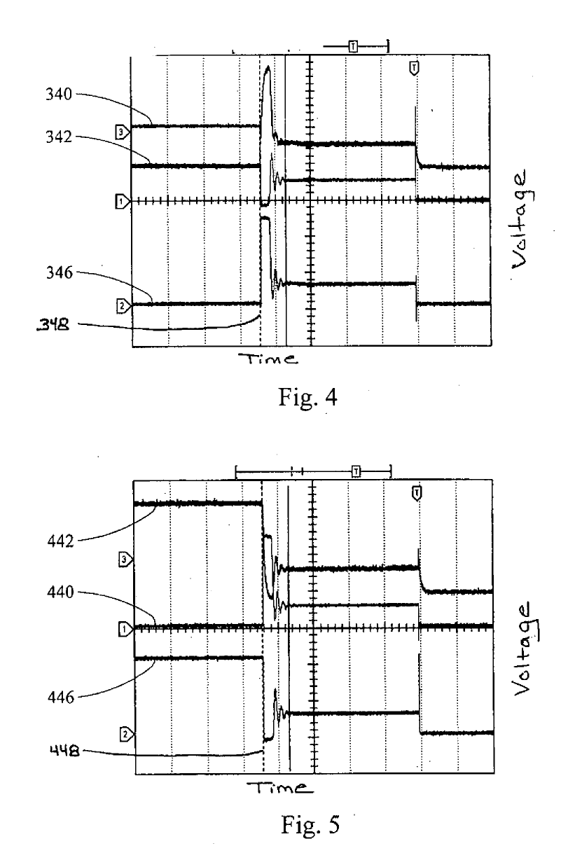

FIG. 4 corresponds to the condition when the motor is driving into an end stop in the first direction. Similar to FIG. 2, waveforms 340 and 342 correspond to the voltage at the first and second side 36, 38 of the motor 12, respectively, and waveform 346 corresponds to the voltage at node 46. The motor 12 is driven in a first direction as the voltage on the first side 36 of the motor 12 is high (waveform 340). The voltage of waveform 340 jumps significantly from the driven condition to the sample condition as the first and second output 40, 42 are disconnected as noted by line 348. The voltage jumps since no back EMF voltage is generated because the motor 12 is not moving.

Now referring to FIG. 5, a similar scenario can be seen when the motor 12 is driven into an end stop in the other direction. The voltage of waveforms 442 and 446 jump significantly from the driven condition to the sample condition since no back EMF voltage is generated when the motor is not moving. Similar to the previous Figures, waveforms 440 and 442 correspond to the voltage at the first and second side 36, 38 of the motor 12, respectively, and waveform 446 corresponds to the voltage at node 46. In addition, line 448 corresponds to the time when the first and second output 40, 42 are disconnected from the motor 12.

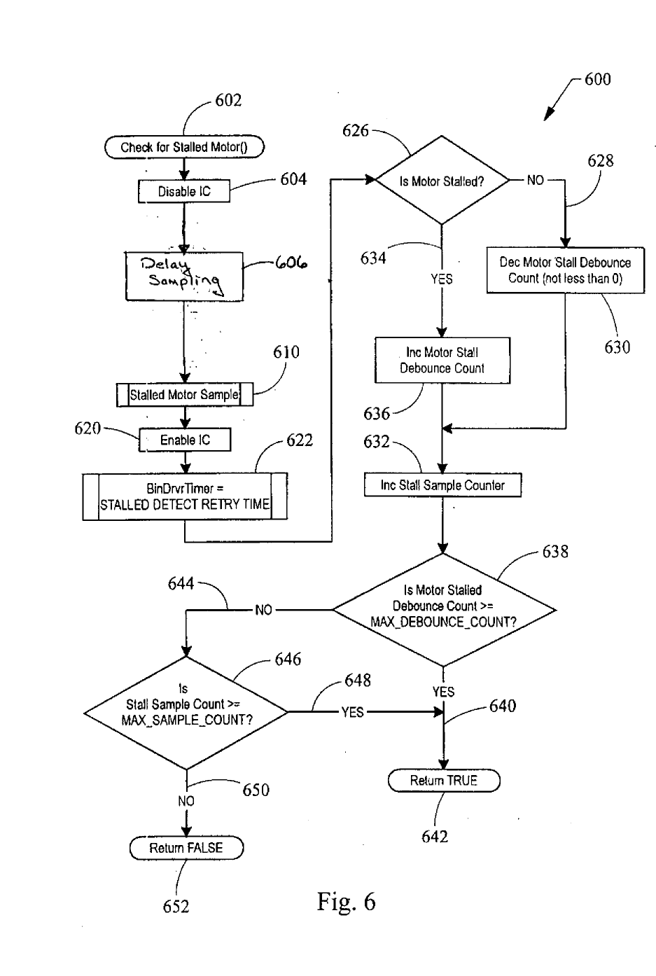

Now referring to FIG. 6, a method 600 is provided for detecting a motor stall. The method 600 starts in block 602. In block 604, the voltage driver circuit 14 is disabled, accordingly outputs 40 and 42 are disconnected, for example by switch 20. In block 606, the system delays for an appropriate amount of time so that the analog signal settles to its proper level for sampling in block 610. For example, a 16 msec period of time may be required as seen in the previous FIGS. 2 through 5. In block 610, a sample is taken by the voltage sensing circuit 16. In block 620, the voltage driver circuit 14 is enabled, accordingly output 40 and 42 are reconnected to the motor 12. In block 622, the timer is reset for triggering the time the next sample is to be acquired. In block 626, the system determines if the motor 12 is stalled based on the measurement by the voltage sensing circuit 16. If the system determines the motor 12 is not stalled, the method 600 follows line 628 and the debounce counter is decremented, so long as, the counter is not less than zero as denoted by block 630. If the motor 12 is stalled, the method follows line 634 to block 636. In block 636, the motor stall counter is incremented and the method proceeds to block 632. In block 632, the sample counter is incremented and the method proceeds to block 638. In block 638, the system determines if the motor stall counter is greater than or equal to the maximum motor stall threshold. The method proceeds along line 640 to block 642 where a true response is returned and the method ends. If the motor stall counter is not greater than or equal to the maximum counter threshold, the method follows line 644 to block 646. In block 646, the system determines if the sample counter is greater than or equal to a maximum counter threshold. If the stall sample counter is greater than or equal to a maximum sample counter threshold, the method follows line 648 to block 642 where a true result is returned and the method ends. Alternatively, if the stall sample count is not greater than or equal to the sample counter threshold, the method follows line 650 to block 652 where a false result us returned and the method ends.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

We claim:

1. A system for detecting when a motor is stalled, the system comprising:
a voltage driver circuit configured to provide a driving signal to the motor at a connection node, wherein the voltage driver circuit is configured to disconnect from the connection node;
a voltage sensing circuit in communication with the motor and configured to determine if the motor is stalled based on a generated voltage from the motor.

2. The system according to claim 1, wherein the voltage driving circuit includes an output for providing the driving signal to the motor, the output having a high impedance mode to disconnect the output from the connection node.

3. The system according to claim 1, wherein the voltage driving circuit is an H-bridge circuit.

4. The system-according to claim 1, wherein the voltage sensing circuit includes an analog to digital converter.

5. The system according to claim 1, wherein the voltage driver circuit is configured to reconnect to the connection node and provide the driving signal to the motor if the generated voltage is greater than a threshold voltage when the voltage driver circuit is disconnected.

6. The system according to claim 1, wherein the voltage driver circuit remains disconnected if the generated voltage is below a threshold voltage.

7. The system according to claim 1, wherein the voltage driver circuit is configured to synchronize measurement of the generated voltage with disconnection of the voltage driver circuit from the connection node.

8. The system according to claim 1, wherein the voltage driver circuit is configured to periodically disconnect from the connection node and the voltage sensing circuit is configured to sample the generated voltage when the voltage driver circuit is disconnected.

9. The system according to claim 8, wherein the voltage driver circuit remains disconnected if the generated voltage is below a threshold voltage for a predetermined number of samples.

10. The system according to claim 1, wherein the threshold voltage is updated periodically.

11. The system according to claim 1, wherein the voltage driver circuit is configured to disconnect from the connection node at a constant frequency.

12. The system according to claim 1, wherein the voltage sensing circuit is configured to determine if the motor is stalled based on a rate of change of the generated voltage.
